(19) United States
(12) Patent Application Publication
(10) Pub. No.: US 2025/0123211 A1
(43) Pub. Date: Apr. 17, 2025

(54) DETECTION, IDENTIFICATION AND SORTING OF CELLS AND CELL-ASSOCIATED TARGET COMPOUNDS USING RAMAN SPECTROSCOPY

(71) Applicant: Battelle Memorial Institute, Columbus, OH (US)

(72) Inventors: Christopher SCHEITLIN, Columbus, OH (US); Ryan W. DALY, Columbus, OH (US); Thomas M. MALOTT, Centerburg, OH (US); Collin F. DUNLAP, New Albany, OH (US); Andrew A. MATAS, Columbus, OH (US); Katarzyna H. KUCHARZYK, Columbus, OH (US); Philip Patrick CHENEY, Bexley, OH (US)

(73) Assignee: BATTELLE MEMORIAL INSTITUTE, Columbus, OH (US)

(21) Appl. No.: 18/915,077

(22) Filed: Oct. 14, 2024

Related U.S. Application Data
(60) Provisional application No. 63/590,212, filed on Oct. 13, 2023.

(51) Int. Cl. G01N 21/65; G01N 21/01; G01N 21/05; G01N 21/95

(52) U.S. Cl. CPC G01N 21/65; G01N 21/05; G01N 21/95; G01N 2021/0106; G01N 2021/052; G01N 2021/651

(57) ABSTRACT

Disclosed herein are systems, devices and methods for detection, identification and sorting of cells and/or cellular-associated targets. The system comprises at least a microfluidic device and a Raman detection and identification unit. The microfluidic device comprises a junction structure aligned with the Raman detection and identification unit, wherein a cell confined at the junction structure is detected and analyzed by the Raman detection and identification unit and routed into a collection channel based on analysis of Raman spectra.

### CROSS-REFERENCE TO RELATED APPLICATIONS

This application claims priority to and benefit of U.S. Provisional Application 63/590,212, filed on Oct. 13, 2023, titled “DETECTION, IDENTIFICATION AND SORTING OF CELLS AND CELL-ASSOCIATED TARGET COMPOUNDS USING RAMAN SPECTROSCOPY”, the disclosure of which is incorporated herein in its entirety.

### STATEMENT REGARDING FEDERALLY SPONSORED RESEARCH

This invention was made with government support under Contract No. FA8650-22-C-7213 awarded by the Defense Advanced Research Projections Agency (DARPA). The government has certain rights in the invention.

### FIELD OF INVENTION

The present application relates to systems, devices and methods for detection, identification and sorting of cells. More specifically, the invention pertains to use of Raman spectroscopy for detection, identification and sorting of cells or cell-associated target compounds.

### BACKGROUND

Through the analysis of the spectrum generated by inelastic scattering of special light on chemical bonds, Raman spectroscopy can detect the molecular vibrational or rotational energy level of bonds directly. The constitution and structure information of a compound can be acquired by analyzing its Raman spectrum, i.e. its identification fingerprint. Raman spectroscopy has also been used for single-cell detection, identification, and sorting. Current methods include identification of cell species, cell size etc. Raman based techniques are advantageous to other identification techniques, because there is no need to label the cell before acquiring its identification fingerprint, and it can operate on single cells and/or groups of cells. Current single-cell detection/identification/sorting techniques have various drawbacks, including false positives, low sensitivity, poor specificity, and/or the inadvertent destruction of the cell.

In summary, there is a need for single-cell interrogation and sorting system with an increased accuracy and providing a comprehensive spectral output without the risk of cell destruction.

### SUMMARY

Disclosed herein are systems, devices and a methods for detection, identification and sorting of individual cells, using Raman spectroscopy. More specifically, the systems and methods pertain to detection, identification and sorting of cells and/or cell-associated targets, such as molecules, compounds or elements, that are either intracellularly located or surface bound to the cells extracellularly. The cell-associated targets of interest can include, but are not limited to, rare earth elements (REEs), lipids, metals, energetic precursors (including cage and linear molecules), fiber precursors, proteins, carbohydrates, sugars, DNA, and other cellular produced compounds.

In one embodiment, a system for detection, identification and sorting of cells or cellular-associated targets incorporates a microfluidic device and a Raman detection and identification unit. The microfluidic device utilizes a junction structure that is aligned with the Raman detection and identification unit. In certain embodiments, the junction structure is sized appropriately so that it can hold a single droplet containing a cell (or collection of cells), so that the Raman detection and identification unit can detect and perform analysis on the cell.

Other systems, devices, methods, features, and advantages will be or become apparent to one with skill in the art upon examination of the included figures and detailed description. It is intended that all such additional systems, devices, methods, and advantages included within this description, be within the scope of the present disclosure, and be protected by the accompanying claims.

### Selected Definitions

As used herein, “weight percent,” “wt %, “percent by weight,” “% by weight,” and variations thereof refer to the concentration of a substance as the weight of that substance divided by the total weight of the composition and multiplied by 100.

As used herein, “molar percent,” “mol %”, “percent by mol,” and variations thereof refer to the relative content of a substance as the mole of that substance divided by the total mole of the composition and multiplied by 100.

As used herein, “volumetric percent,” “vol %”, “percent by volume,” and variations thereof refer to the relative content of a substance as the volume of that substance divided by the total volume of the composition and multiplied by 100.

As used herein, “g” represents gram; “L” represents liter; “mg” represents “milligram (10-3 gram);” “μg” equals to one microgram (10-6 gram) and “fg” equals one femtogram (10-15 gram). “mL” or “cc” represents milliliter (10-3 liter). One “μL” equals to one microliter (10-6 liter). The units “mg/100 g,” “mg/100 mL,” or “mg/L” are units of concentration or content of a component in a composition. One “mg/L” equals to one ppm (part per million). “Da” refers to Dalton, which is the unit for molecular weight; One Da is equivalent to one g/mol. The unit of temperature used herein is degree Celsius (° C.).

The term “about” is used in conjunction with numeric values to include normal variations in measurements as expected by persons skilled in the art, and is understood to have the same meaning as “approximately” and to cover a typical margin of error, such as ±15%, ±10%, ±5%, ±1%, ±0.5%, or even ±0.1% of the stated value. The term “about” also encompasses amounts that differ due to different equilibrium conditions for a composition resulting from a particular initial composition. Whether or not modified by the term “about,” the claims include equivalents

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise. As used herein, “and/or” refers to and encompasses any and all possible combinations of one or more of the associated listed items, as well as the lack of combinations when interpreted in the alternative (“or”).

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

The term “comprise,” “comprises,” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed invention.

Thus, the term “consisting essentially of” when used in a claim of this invention is not intended to be interpreted to be equivalent to “comprising.”

As used herein, the terms “increase,” “increasing,” “increased,” “enhance,” “enhanced,” “enhancing,” and “enhancement” (and grammatical variations thereof) describe an elevation of at least about 1%, 5%, 10%, 15%, 25%, 50%, 75%, 100%, 150%, 200%, 300%, 400%, 500% or more as compared to a control.

As used herein, the terms “reduce,” “reduced,” “reducing,” “reduction,” “diminish,” and “decrease” (and grammatical variations thereof), describe, for example, a decrease of at least about 1%, 5%, 10%, 15%, 20%, 25%, 35%, 50%, 75%, 80%, 85%, 90%, 95%, 97%, 98%, 99%, or 100% as compared to a control. In particular embodiments, the reduction can result in no or essentially no (i.e., an insignificant amount, e.g., less than about 10% or even 5% or even 1%) detectable activity or amount.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

### BRIEF DESCRIPTION OF THE DRAWINGS

FIG. 1 shows a schematic of a system for detection, identification and sorting of cell-associated targets, in accordance with embodiments disclosed herein.

FIG. 2 depicts a cross sectional view of channels and a junction structure within a microfluidic device, in accordance with embodiments disclosed herein.

FIG. 3 illustrates a microfluidic device for detection, identification and sorting of cell-associated targets, in accordance with embodiments disclosed herein.

FIG. 4 shows three comparative Raman fingerprints of E. coli cultures, with graph A showing Raman spectra of pure E. coli cells, graph B showing Raman spectra of E. coli+Neodymium (Nd), and graph C showing Raman spectra of E. coli+Lanthanum (La).

FIG. 5 illustrates methods for detection, identification and sorting of cells or cell-associated targets, in accordance with embodiments disclosed herein.

### DETAILED DESCRIPTION

The present disclosure relates to a system, device and a methods for detection, identification and sorting of individual cells, using Raman spectroscopy. More specifically, embodiments disclosed herein pertain to identification and sorting of cells or cell-associated targets, such as molecules, compounds or elements, that are either intracellularly located or surface bound to the cells extracellularly. The cell-associated targets of interest can include but are not limited to rare earth elements (REEs), lipids, metals, energetic precursors (including cage and linear molecules), fiber precursors, proteins, carbohydrates, sugars, DNA, and other cellular produced compounds. In the embodiments disclosed herein, it is understood that the cell-associated targets of interest which are to be identified, may originate from cellular metabolism or from cellular interaction with environment including uptake, adsorption/absorption, or other association with foreign material.

Particularly in the case of rare earth elements (REEs), research has shown that microorganisms can extract certain elements from the environment. For example, certain types of bacteria selectively take up lanthanides and incorporate into enzymes for use as metabolic catalysts. REEs are of particular interest in recent years due to their indispensability in electronic devices, including smartphones, computers, and electric motors. Sourcing and extraction of these elements is often a complicated process, which cannot be carried out in an environmentally benign and sustainable way. Hence, interest in extraction mechanisms for REEs by microorganisms has received increased attention in recent years.

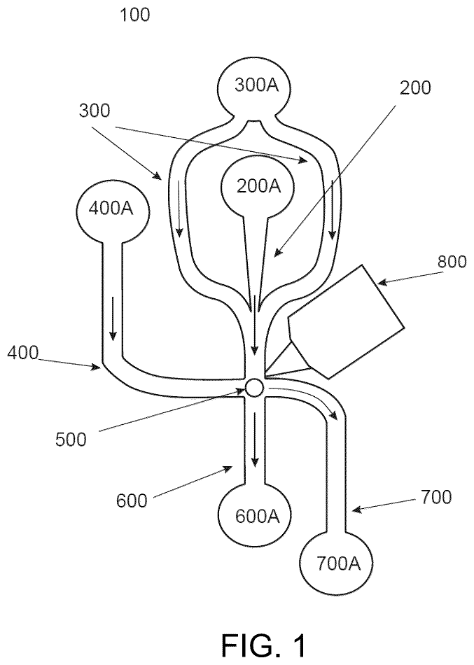

In one embodiment, the disclosure pertains to a system for detection, identification and sorting of cells or cellular-associated targets. The system incorporates a microfluidic device and a Raman detection and identification unit. The microfluidic device 100 utilizes a junction structure 500 which is aligned with the Raman detection and identification unit 800. In one embodiment, a cell of interest is loaded onto the microfluidic device 10 encapsulated in a droplet. The droplet containing the cell is confined at the junction structure for analysis by the Raman detection and identification unit 800. Thereafter, the droplet containing the cell is routed into at least one collection channel. If the analysis determines that the cell incorporates the cellular-associated target of interest then it is routed to a positive collection channel. In the alternative, the cell is routed to a negative collection channel. Through this process, cell or cell-associated targets of interest are able to be separated and sorted from other types of cells. Details of one embodiment of a microfluidic device of this system, are depicted in FIG. 1.

A microfluidic device 100 for use in the systems and methods disclosed herein is shown in FIG. 1. The device comprises:
a main flow channel 200;
at least one lateral carrier channel(s) 300;
a junction structure 500 located at a channel junction;
a sorting channel 400; and
at least one collection channel, comprised of a positive collection channel 600 and negative collection channel 700.

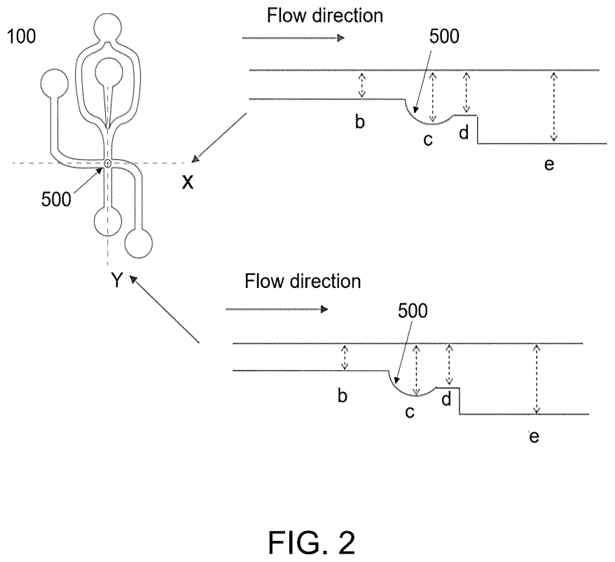

Samples of interest enter through port 200A, with carrier fluids (e.g carrier oils) entering through ports 300A and 400A, and exiting at ports 600A and 700A. Although not showing, tubing may be connected to the entry and exit ports. The junction structure 500 shown in FIG. 1 and FIG. 2 is sized appropriately so that it can hold a single droplet containing a cell (or collection of cells), so that the Raman detection and identification unit 800 can detect and identify the cell. As can be seen in FIG. 2, in the cross-sectional views along axis X and axis Y at the junction structure 500, in one embodiment the junction structure 500 is a recessed structure, having a central depth c. In other embodiments, the junction structure 500 can be raised structure, appropriately sized to hold a single droplet, a flat recessed structure without any curvature, or a flush structure without being recessed. Each of the structures in the microfluidic device will now be discussed in more detail.

In one embodiment, the main flow channel 200 shown in FIG. 1 is where the cell sample to be analyzed will enter from port 200A. In certain embodiments, cells entering the microfluidic device 100 at port 200A, will already be encompassed within an emulsion droplet (for example, comprising a water/oil emulsion) then travel through the main flow channel 200. In other embodiments, the cell may be placed into the main flow channel without first being dropletized. For example, the cells can be organized in line by using laminar sheath flow of a carrier fluid (similar to flow cytometry). In this embodiment, the junction may be coupled to or comprise means for holding the cells static, such as an electromagnetic field which can be utilized to stabilize the cell at the junction. Other options include use of optical or acoustic tweezers, which are already known and disclosed in the current state of the art. It is to be understood that the configuration of the junction can be modified and the examples disclosed herein are not limiting to the invention. For purposes of the remainder of the disclosure, there will be reference made to embodiments which contain a recessed structure for the junction (such as that shown in FIG. 2). Although it is to be understood that the remainder of the system and methods disclosed here assume that the junction shape, configuration, and means for holding the cell static can be modified to include any structures or means suitable for mobilizing the cell at that location within the microfluidic device.

In the embodiment shown in FIG. 1, prior to placement within the microfluidic device, the cell is separated from single or mixed culture samples, and a droplet generator can be used to produce 1-100 micron sized droplets, or 1-50 micron, or 1-40 micron, or 1-30 micron, or 1-20 micron, or 1-10 micron, or 1-5 microns. A commercially available droplet generator can be used for purposes of dropletizing the individual cells. The dropletized individual cells are placed into a cell reservoir preceding the main flow channel of the microfluidic device and enter the channel through a valve (not shown) which controls their flow down the main flow channel towards the junction 500 having the recessed structure. In one embodiment, the valve is a pneumatic microvalve. Once in the recessed structure 500, the dropletized cell is then stationary and no longer moving through the channels, which allows for Raman detection and identification from the Raman detection and/or identification unit 800 to proceed efficiently. The droplet size will range between 1-50 microns, or 1-40 microns, or 1-30 microns, or 1-20 microns, or 1-10 microns, or 1-5 microns.

On either side of the main flow channel 200 are two lateral carrier channels 300, where a carrier fluid is provided in port 300A to aid in the flow of the dropletized cell towards the junction having the recessed structure. Oil can be used as the carrier fluid for the emulsion based droplets containing the individual cells. In one embodiment, the oil comprises a fluorinated carrier oil, a mineral oil, or other known oils which are suitable as carrier liquids in microfluidic cell sorting applications.

Once the drop containing the individual cell resides in the recessed structure, Raman based analysis can occur. The Raman detection and identification unit 800 comprises a Raman Spectrometer aligned directly above the recessed structure 500. For increased strength of reflected signal, the recessed structure 500 section will have a metallized coating, to be mirror-like and be reflective of optical signals from the Raman spectrometer 800. This will ensure high accuracy of the generated Raman spectra emitted from the cell, without interference from the surrounding medium, including the substrate material of the microfluidic device. The metallized coating can be present solely at the junction structure 500, or also throughout the other channels of the microfluidic device. The metallized coating can comprise aluminum coating, which results in a highly reflective surface. Other reflective metals which are known to those skilled in the art can also be utilized. The coating preferably has a thickness of about 200 to 1500 nm, or 500-1400 nm, or 800-1000 nm, or any value or range of values therebetween.

An example of Raman spectrometers, systems and methods that can be utilized with this invention are identified in Applicant's prior patent applications and/or granted patents, U.S. Pat. No. 10,126,169B2, U.S. Pat. No. 8,441,632 B2, U.S. Pat. No. 9,354,146 B1, WO 2020/041307 A1, U.S. Pat. No. 11,381,059B2, the relevant sections of which are incorporated herein in their entirety. It is expected that the cell will remain in the recessed structure 500 for a period of 5 seconds to 1 minute, in order for the necessary Raman based detection/identification and analysis to occur, before the system determines the next path of the cell.

The device 100 shown in FIG. 1, further incorporates a sorting channel 400, which is connected to the junction where the recessed structure 500 resides. The sorting channel 400 is configured to incorporate a valve to control the flow of carrier fluid (oil) down the channel and to the recessed structure 500 where the cell is located. If based on the Raman spectra analysis a determination has been made that the cell contains the cell-associated target of interest, the sorting channel 400 valve (not shown) can be actuated to release the carrier fluid which will carry the cell from the recessed structure 500 and into a positive collection channel 600. If the analysis determines the cell does not contain the target of interest, then it will proceed to flow down the negative collection channel 700. In this manner, sorting can occur between cells either having or being void of the cell-associated target of interest. The cells which incorporate the target can be collected in the positive collection channel 600 through port 600A and further studied or processed based on the appropriate determined protocols for that target of interest.

As noted above, the cell-associated targets of interest can comprise molecules, compounds, and/or elements which are externally surface bound or intracellular. In some embodiments, the cell-associated targets comprise rare earth elements, lipids, metals, energetic precursors, fibers, proteins, carbohydrates, sugars, DNA, and other cellular produced compounds, or a combination thereof. In embodiments where the target of interest is a rare earth element, the element will comprise lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y), or a combination thereof.

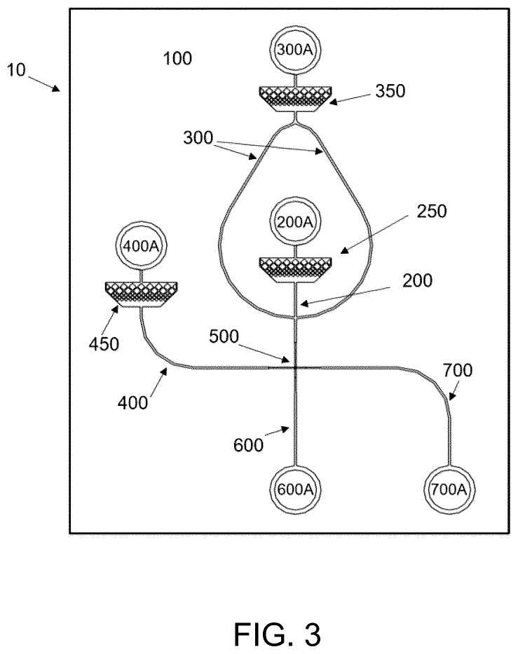

In a further embodiment, shown in FIG. 3, the microfluidic device further incorporates filter traps 250, 350 and 450, for trapping larger particles which would otherwise block the flow of cells or materials of interest through the microfluidic device. Also shown in FIG. 3 is the substrate 10, whereon the microfluidic device 100 is formed.

In some embodiments, the system disclosed herein further comprises an analysis module (not shown in FIG. 1). This may include electromagnetic or electrical sensors, lenses, and/or filters. This module is configured to communicate with the Raman detection unit, for analyzing spectra from the Raman detection unit. The analysis module is configured to determine whether a cell contained in the recessed unit is routed to the negative collection channel or positive collection channel.

Shown in FIG. 2 are cross-sectional views along the X and Y axes of the recessed structure at the junction 500, outlining various measurement parameters of the channels and recessed structure at the junction. Measurement b represents the depth of sorting channel 400, c the center depth of junction structure 500, d a first depth of either channel 600 or 700, immediately following and adjacent to the recessed structure 500, and depth e represents the second depth of channel 600 or 700, wherein d can be larger than e, in certain embodiments. The purpose of depth d is to assist the cell from flowing from the recessed junction structure 500 and into either the positive or negative collection channels 600 or 700.

Table 1 below lists various measurement parameters and dimensions thereof, in micrometers (μm), of the junction and channel related parameters shown in FIG. 2.

TABLE 1

| | Shape of Channel Bottom at Junction | | | | | |
|---|---|---|---|---|---|---|
| | Curve | Curve | Curve | Curve | Curve | |
| Variable | Recess | Recess | Recess | Recess | Recess | Flush |
| b | 15 | 25 | 30 | 40 | 20 | 30 |
| c | 30 | 30 | 40 | 50 | 50 | 30 |
| d | 15 | 20 | 30 | 40 | 20 | 30 |
| e | 100 | 100 | 100 | 100 | 100 | 100 |
| width at | 20 | 25 | 30 | 40 | 30 | 30 |
| junction | | | | | | |

| | Shape of Channel Bottom at Junction | | | | | |
|---|---|---|---|---|---|---|
| | Flat | Flat | Flat | Flat | | |
| Variable | Recess | Recess | Recess | Recess | Flush | Flush |
| b | 20 | 20 | 35 | 35 | 10 | 15 |
| c | 30 | 40 | 40 | 50 | 10 | 15 |
| d | 20 | 20 | 35 | 35 | 10 | 15 |

In some embodiments, the recessed structure comprises a concave configuration, having a center depth c of about 3 to 60 microns, or 10-50 microns, or 20-40 microns, or any value therebetween. The depth, b, of the channels (main flow, sorting, or positive/negative collection channels) is in the range of 10 to 50 microns, or about 20 to 40 microns, or 25 to 35 microns, or any value therebetween. In other embodiments, the shape of the recessed structure can be flat, and not curved or concave. Other embodiments also allow for the shape of the juncture 500 to be flush and not recessed.

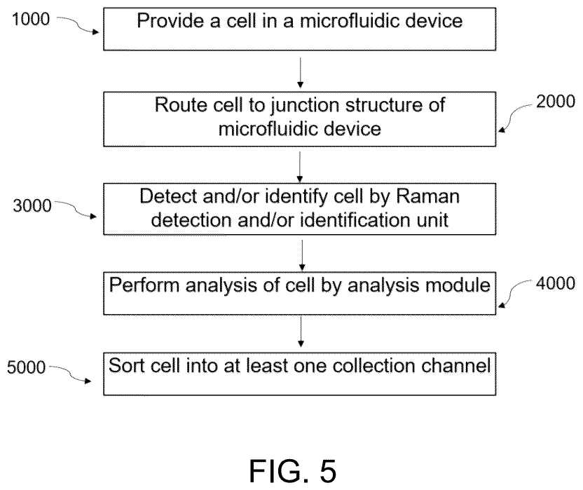

Also disclosed herein are methods for detection, identification and sorting of cells and/or cell-associated targets. The methods comprise at least the following steps, which are also illustrated in FIG. 5. First the method comprises a step 1000 of providing a cell in a microfluidic device; step 2000 of routing the cell to a junction structure in the microfluidic device; step 300 of detecting the cell at the junction structure by a Raman detection and identification unit; step 4000 of performing analysis of the cell by an analysis module; and step 5000 of sorting the cell into at least one collection channel, based on the analysis performed by the analysis module. In some embodiments, the junction structure is a recessed or raised structure, which is appropriately sized to hold a droplet containing a cell. In one embodiment, the method comprises providing a cell which is already encapsulated in a droplet. In other embodiments, the cell is provided in a carrier fluid and not previously dropletized. The analysis module is coupled to the Raman detection unit and analyzes spectra output from the Raman detection unit. The microfluidic devices disclosed above are utilized in the present method.

In one embodiment, the sorting channel in the microfluidic device is activated to route a cell to the positive collection channel, if the analysis module has determined the presence of a cell-associated target of interest.

The analysis module utilized in step 4000 incorporates software comprising algorithms which carry out comparative analysis of the Raman spectra for each cell being detected in the recessed structure. The algorithm is configured to compare the spectral fingerprint of the current cell with a database for that cell, in order to determine if the cell incorporates the target of interest or if the target is not present. The algorithm may also be configured to quantify the target of interest.

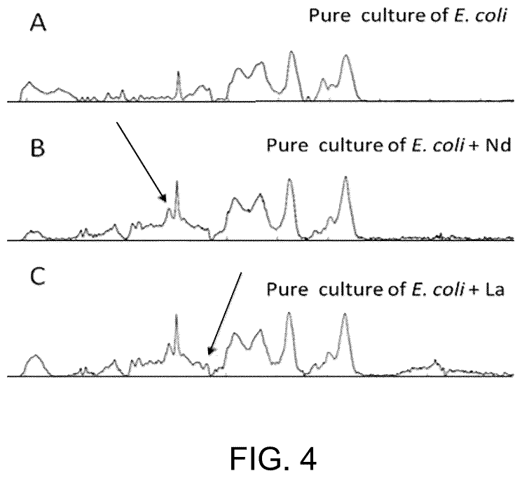

The algorithm analyzes Raman spectral data from cells with and without the cell-associated target of interest to detect presence of the cell-associated target of interest and determine if the cell sample will be routed to the positive or negative collection channel. As an example, comparisons of this type of spectra analysis are shown in FIG. 4, wherein an E. coli cell spectra (A) is compared to a cell containing the rare earth element Nd (B) and cell containing Lanthanum (C). The signature or fingerprint of E. coli cell spectra is visibly different when Nd is detected and when La is detected, as compared to a cell void of these elements. Due to the nature of the Raman analysis, it may be able to perform its detection and analysis accurately without visible spectral differences.

Further embodiments and examples of the current invention are illustrated in the enumerated clauses which follow.

Clause 1. A system for detection, identification and sorting of cells and/or cellular-associated targets, comprising:
a microfluidic device;
a Raman identification and detection unit;
wherein the microfluidic device comprises a junction structure aligned with the Raman detection unit, and wherein a droplet confined at the junction structure is detected and analyzed by the Raman identification and detection unit and routed into at least one collection channel.

Clause 2. The system of clause 1, wherein the microfluidic device comprises:
a main flow channel;
at least one lateral carrier channel(s);
the junction structure located at a channel junction;
a sorting channel; and
the at least one collection channel, comprised of a positive collection channel and negative collection channel.

Clause 3. The system of clause 1, wherein the junction structure is a raised or recessed structure comprising a metallized coating layer.

Clause 4. The system of clause 1, wherein the cell-associated targets comprise molecules, compounds, or elements which are externally surface bound or intracellular.

Clause 5. The system of clause 1, wherein the cell-associated targets comprise rare earth elements, lipids, metals, energetic precursors, fibers, proteins, carbohydrates, sugars, DNA, and other cellular produced compounds, or a combination thereof.

Clause 6. The system of clause 1, wherein the cell-associated targets comprise rare earth elements selected from the group consisting of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y), or a combination thereof.

Clause 7. The system of clause 3, wherein recessed structure is configured to hold a droplet comprising at least one cell for Raman identification and detection.

Clause 8. The system of clause 1, wherein the microfluidic devices comprises two lateral carrier channels on each side of the main flow channel.

Clause 9. The system of clause 1, wherein the Raman identification and detection unit comprises a Raman Spectrometer aligned directly above the junction structure.

Clause 10. The system of clause 1, further comprising an analysis module configured to communicate with the Raman detection and identification unit, for analyzing spectra from the Raman detection and identification unit.

Clause 11. The system of clause 2, wherein the analysis module is configured to determine whether a cell contained in the junction structure is routed to the negative collection channel or positive collection channel.

Clause 12. The system of clause 10, wherein the sorting channel is configured to route a cell to the positive collection channel, if the analysis module has determined the presence of a cell or interest or cell-associated target of interest.

Clause 13. The system of clause 3, wherein the recessed structure comprises a concave configuration, having a center depth of about 3 to 60 μm.

Clause 14. The system of clause 1, wherein the main flow channel has a depth of about 10-50 μm.

Clause 15. A method for detection, identification and sorting of cells or cell-associated targets, comprising:
providing a cell in a microfluidic device;
routing the cell to a junction structure in the microfluidic device;
detecting and/or identifying the cell at the junction structure by a Raman detection and identification unit;
performing analysis of the cell by an analysis module; and
sorting the cell into at least one collection channel, based on the analysis performed by the analysis module.

Clause 16. The method of clause 15, wherein the analysis module is coupled to the Raman detection unit and analyzes spectra output from the Raman detection and identification unit.

Clause 17. The method of clause 15, wherein the analysis module comprises an algorithm configured to identify cells with or without the cell-associated target of interest.

Clause 18. The method of clause 15, wherein the microfluidic device comprises:
a main flow channel;
at least one lateral carrier channel(s);
the junction structure located at a channel junction;
a sorting channel; and
the at least one collection channel, comprised of a positive collection channel and negative collection channel.

Clause 19. The method of clause 18, wherein the junction structure is a recessed structure of comprising a metallized coating layer.

Clause 20. The method of clause 15, wherein the cell-associated targets comprise rare earth elements selected from the group consisting of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y), or a combination thereof.

Clause 23. The method of clause 18, wherein recessed structure Is configured to hold a droplet comprising a cell or collection of cells for Raman detection.

Clause 24. The method of clause 19, wherein the microfluidic devices comprises two lateral carrier channels on each side of the main flow channel.

Clause 25. The method of clause 15, wherein the Raman detection and identification unit comprises a Raman Spectrometer aligned directly above the recessed structure.

Clause 26. The method of clause 18, wherein the analysis module is configured to determine whether a cell contained in the junction structure is routed to the negative collection channel or positive collection channel.

Clause 27. The method of clause 18, wherein the sorting channel is configured to route a cell to the positive collection channel, if the analysis module has determined the presence of a cell-associated target of interest.

Clause 28. The method of clause 19, wherein the recessed structure comprises a concave configuration, having a center depth of about 3 to 60 microns.

Clause 29. The method of clause 18, wherein the main flow channel has a depth of about 10-50 microns.

Clause 30. The method of clause 17, wherein the algorithm analyzes Raman spectral data from cells with and without the cell-associated target of interest to detect presence of a cell or cell-associated target of interest and determine if the cell will be routed to the positive or negative collection channel.

The above specification, examples and data provide a complete description of the manufacture and use of the composition of the disclosure. Since many embodiments of the disclosure can be made without departing from the spirit and scope of the disclosure, the disclosure resides in the claims hereinafter appended.

What is claimed is:

1. A system for detection, identification and sorting of cells and/or cellular-associated targets, comprising:
a microfluidic device;
a Raman identification and detection unit;
wherein the microfluidic device comprises a junction structure aligned with the Raman detection unit, and wherein a droplet confined at the junction structure is detected and analyzed by the Raman identification and detection unit and routed into at least one collection channel.

2. The system of claim 1, wherein the microfluidic device comprises:
a main flow channel;
at least one lateral carrier channel(s);
the junction structure located at a channel junction;
a sorting channel; and
the at least one collection channel, comprised of a positive collection channel and negative collection channel.

3. The system of claim 1, wherein the junction structure is a raised or recessed structure comprising a metallized coating layer.

4. The system of claim 1, wherein the cell-associated targets comprise molecules, compounds, or elements which are externally surface bound or intracellular.

5. The system of claim 1, wherein the cell-associated targets comprise rare earth elements, lipids, metals, energetic precursors, fibers, proteins, carbohydrates, sugars, DNA, and other cellular produced compounds, or a combination thereof.

6. The system of claim 1, wherein the cell-associated targets comprise rare earth elements selected from the group consisting of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y), or a combination thereof.

7. The system of claim 3, wherein recessed structure is configured to hold a droplet comprising at least one cell for Raman identification and detection.

8. The system of claim 1, wherein the microfluidic devices comprises two lateral carrier channels on each side of the main flow channel.

9. The system of claim 1, wherein the Raman identification and detection unit comprises a Raman Spectrometer aligned directly above the junction structure.

10. The system of claim 1, further comprising an analysis module configured to communicate with the Raman detection and identification unit, for analyzing spectra from the Raman detection and identification unit.

11. The system of claim 2, wherein the analysis module is configured to determine whether a cell contained in the junction structure is routed to the negative collection channel or positive collection channel.

12. The system of claim 10, wherein the sorting channel is configured to route a cell to the positive collection channel, if the analysis module has determined the presence of a cell or interest or cell-associated target of interest.

13. The system of claim 3, wherein the recessed structure comprises a concave configuration, having a center depth of about 3 to 60 μm.

14. The system of claim 1, wherein the main flow channel has a depth of about 10-50 μm.

15. A method for detection, identification and sorting of cells or cell-associated targets, comprising:
providing a cell in a microfluidic device;
routing the cell to a junction structure in the microfluidic device;
detecting and/or identifying the cell at the junction structure by a Raman detection and identification unit;
performing analysis of the cell by an analysis module; and
sorting the cell into at least one collection channel, based on the analysis performed by the analysis module.

16. The method of claim 15, wherein the analysis module is coupled to the Raman detection unit and analyzes spectra output from the Raman detection and identification unit.

17. The method of claim 15, wherein the analysis module comprises an algorithm configured to identify cells with or without the cell-associated target of interest.

18. The method of claim 15, wherein the microfluidic device comprises:
a main flow channel;
at least one lateral carrier channel(s);
the junction structure located at a channel junction;
a sorting channel; and
the at least one collection channel, comprised of a positive collection channel and negative collection channel.

19. The method of claim 18, wherein the junction structure is a recessed structure of comprising a metallized coating layer.

20. The method of claim 15, wherein the cell-associated targets comprise rare earth elements selected from the group consisting of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y), or a combination thereof.
